(19) United States
(12) Patent Application Publication
(10) Pub. No.: US 2024/0428081 A1
(43) Pub. Date: Dec. 26, 2024

(54) Generative Artificial Intelligence Model Analytics System

(71) Applicant: Trustwise, Austin, TX (US)

(72) Inventors: Richard Knuszka, Hampshire (GB); Seth Dobrin, Ridgefield, CT (US); Matthew Barker, Edenbridge (GB); Avinash Saxena, Katy, TX (US)

(21) Appl. No.: 18/752,580

(22) Filed: Jun. 24, 2024

Related U.S. Application Data
(60) Provisional application No. 63/522,913, filed on Jun. 23, 2023.

(51) Int. Cl. G06N 3/096; G06N 3/0475

(52) U.S. Cl. CPC G06N 3/096; G06N 3/0475

(57) ABSTRACT

According to an aspect of an embodiment, a method for performing a generative artificial intelligence model analytics operation may include obtaining an artificial intelligence (AI) model. The method may further include performing analysis of the AI model using one or more scoring agents. The method may further include generating a report including results of the analysis and providing the report on a user interface.

### CROSS REFERENCE TO RELATED APPLICATION

This application claims priority to U.S. Provisional Patent Application No. 63/522,913 filed on Jun. 23, 2023, and titled “GENERATIVE ARTIFICIAL INTELLIGENCE MODEL ANALYTICS SYSTEM.” The contents of the application are hereby incorporated by reference in their entirety for all purposes.

### BACKGROUND OF THE INVENTION

### Field of the Invention

The present invention relates to information handling systems. More specifically, embodiments of the invention relate to performing a generative artificial intelligence model analytics operation by a generative artificial intelligence model analytics system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

According to an aspect of an embodiment, a method for performing a generative artificial intelligence model analytics operation may include obtaining an artificial intelligence (AI) model. The method may further include performing analysis of the AI model using one or more scoring agents. The method may further include generating a report including results of the analysis and providing the report on a user interface.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 shows a general illustration of components of an information handling system as implemented in the system and method of the present invention, in accordance with one or more embodiments of the present disclosure;

FIG. 2 shows a block diagram of a generative artificial intelligence model analytics environment, in accordance with one or more embodiments of the present disclosure;

FIG. 3 shows a block diagram of a generative artificial intelligence model analytics system, in accordance with one or more embodiments of the present disclosure;

FIG. 4 shows a functional block diagram of a generative artificial intelligence model analytics system, in accordance with one or more embodiments of the present disclosure;

FIG. 5 is a flow diagram for a process of generating a response using an AI model, in accordance with one or more embodiments of the present disclosure;

FIG. 6 is a flow diagram for a system 600 configured for system of record, in accordance with one or more embodiments of the present disclosure; and

FIG. 7 is a flow chart of an example method of performing analysis of an AI model, arranged in accordance with at least one embodiment of the present disclosure.

### DETAILED DESCRIPTION

A system, method, and computer-readable medium are disclosed for performing a generative artificial intelligence model analytics operation. In certain embodiments, the generative artificial intelligence model analytics operation is performed on language models such as large language models (LLMs).

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

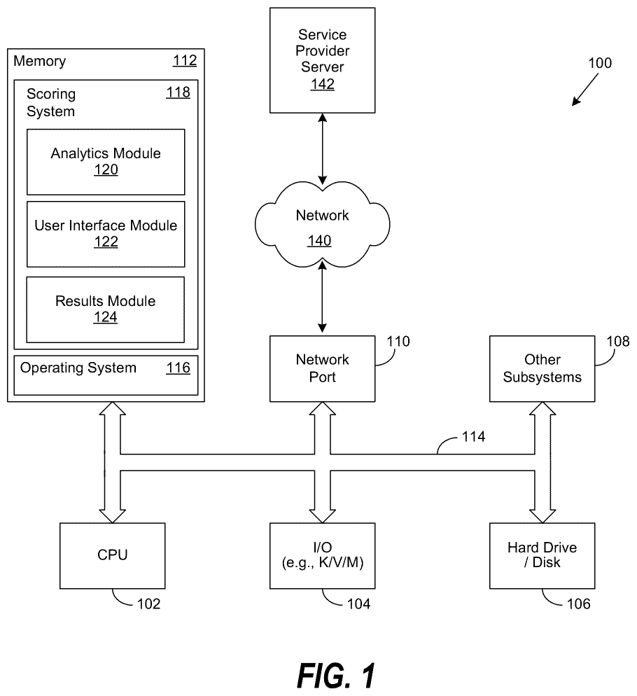

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, a touchpad or touchscreen, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a generative artificial intelligence model analytics system 118. In one embodiment, the information handling system 100 is able to download the generative artificial intelligence model analytics system 118 from the service provider server 142. In another embodiment, the generative artificial intelligence model analytics system 118 is provided as a service from the service provider server 142.

In some embodiments, the information handling system 100 may be configured to be a command center for one or more subsystems and/or other system. For example, the information handling system 100 may be configured to be a central platform in which an operator and/or a developer may use to monitor, manage, and/or control different parts of a system. For example, the information handling system 100 may be used to control subsystems and/or different APIs such as those described with respect to FIGS. 1-7 of the present disclosure.

In some embodiments, the information handling system 100 may include and/or correspond to one or more of a developer portal, a control panel, or a performance center. In these and other embodiments, the developer portal may be a centralized platform configured to provide developers and/or operations with resources, tools, and documentation that may be helpful to effectively use and integrate with a particular set of APIs, services, or technologies. In some embodiments, the control panel may include a centralized interface used for monitoring, managing, and controlling various systems and operations within a system and/or an entity. The control panel may provide a comprehensive view of real-time data, alerts, and controls, which may help enable operators to make informed decisions and respond to situations effectively. In some embodiments, the performance center may be a centralized platform designed to monitor, manage, and optimize the performance of various systems, applications, and networks associated with a system and/or an entity. The performance center may provide tools and insights to ensure that systems are operating efficiently, identify potential issues before they impact users, and improve overall operational performance.

In certain embodiments, the generative artificial intelligence model analytics system 118 may include an analytics module 120, a user interface module 122 and a results module 124. In certain embodiments, the generative artificial intelligence model analytics system 118 may be implemented to perform a generative artificial intelligence model analytics operation. In certain embodiments, the analytics module 120, the user interface module 122 and the results module 124 may be implemented to respectively perform an analytics operation, to generate user interfaces associated with the analytics or the results and to generate results associated with the analytics. In certain embodiments, the analytics operation generates a score associated with analyzing a generative artificial intelligence model. In certain embodiments, the results can include summary information, benchmarking information, indexing information, or a combination thereof.

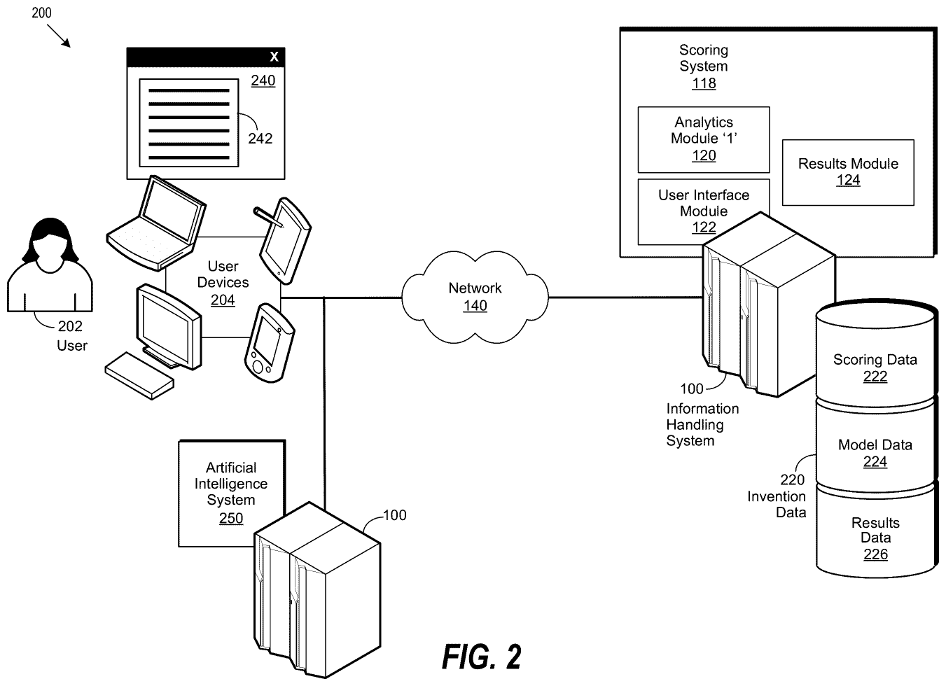

FIG. 2 is a block diagram of a generative artificial intelligence model analytics environment 200 implemented in accordance with an embodiment of the invention. In certain embodiments, the generative artificial intelligence model analytics environment 200 may include a generative artificial intelligence model analytics system 118. In certain embodiments, the generative artificial intelligence model analytics environment 200 may include a repository of generative artificial intelligence model analytics data 220. In certain embodiments, the repository of generative artificial intelligence model analytics data 220 may be local to the system executing the generative artificial intelligence model analytics system 118 or may be executed remotely. In certain embodiments, the repository of generative artificial intelligence model analytics data 220 may include various information associated with scoring data 222, model data 224, and results data 226.

In certain embodiments, a user 202 may use a user device 204 to interact with the generative artificial intelligence model analytics system 118. As used herein, a user device 204 refers to an information handling system such as a personal computer, a laptop computer, a tablet computer, a personal digital assistant (PDA), a smart phone, a mobile telephone, or other device that is capable of communicating and processing data. In certain embodiments, the user device 204 may be configured to present a generative artificial intelligence model analytics system user interface (UI) 240. In certain embodiments, the generative artificial intelligence model analytics system UI 240 may be implemented to present a graphical representation 242 of generative artificial intelligence model analytics information, which is automatically generated in response to interaction with the generative artificial intelligence model analytics system 118.

In certain embodiments, the user device 204 is used to exchange information between the user 202 and the generative artificial intelligence model analytics system 118, and a generative artificial intelligence system 250, through the use of a network 140. In certain embodiments, the network 140 may be a public network, such as a public internet protocol (IP) network, a physical private network, a wireless network, a virtual private network (VPN), or any combination thereof. Skilled practitioners of the art will recognize that many such embodiments are possible and the foregoing is not intended to limit the spirit, scope or intent of the invention.

In various embodiments, the generative artificial intelligence model analytics system UI 240 may be presented via a website. In certain embodiments, the website may be provided by one or more of the generative artificial intelligence model analytics system 118 and the generative artificial intelligence system 250. For the purposes of this disclosure a website may be defined as a collection of related web pages which are identified with a common domain name and is published on at least one web server. A website may be accessible via a public IP network or a private local network.

A web page is a document which is accessible via a browser which displays the web page via a display device of an information handling system. In various embodiments, the web page also includes the file which causes the document to be presented via the browser. In various embodiments, the web page may comprise a static web page, which is delivered exactly as stored and a dynamic web page, which is generated by a web application that is driven by software that enhances the web page via user input to a web server.

In certain embodiments, the generative artificial intelligence model analytics system 118 may be implemented to interact with the generative artificial intelligence system 250, which in turn may be executing on a separate information handling system 100. In certain embodiments, the generative artificial intelligence model analytics system 118 may be implemented to perform a generative artificial intelligence model analytics operation, as described in greater detail herein. As used herein, a generative artificial intelligence model analytics operation broadly refers to any task, function, procedure, or process performed, directly or indirectly, within a generative artificial intelligence model scoring environment 200 to analyze the performance of a generative artificial intelligence model. In certain embodiments, the analyzing is performed by scanning the content of the generative artificial intelligence model.

In certain embodiments, the generative artificial intelligence model analytics operation includes a generative artificial intelligence model safety scoring operation. As used herein, a generative artificial intelligence model safety scoring operation broadly refers to any task, function, procedure, or process performed, directly or indirectly, within a generative artificial intelligence model scoring environment 200 to generate a safety score associated with the performance of a generative artificial intelligence model. In certain embodiments, the generative artificial intelligence model safety analytics operation includes one or more of a remediation operation, a recommendation operation, a summary operation, a benchmarking operation and an indexing operation.

As used herein, a remediation operation broadly refers to any task, function, procedure, or process performed, directly or indirectly, within a generative artificial intelligence model scoring environment 200 to remediate an issue identified when analyzing the generative artificial intelligence model. As part of the remediation operation, the generative artificial intelligence model analytics system 118 can identity a root cause, a next best action on how to address an identified issue. In certain embodiments, the remediation operation includes a process in which the user is able to intervene in the classification of the discoveries and ensure appropriate classification of the model vulnerability. In certain embodiments, the remediation process is initially manual, but will be automated over time, as the system learns based off reinforcement learning.

As used herein, a recommendation operation broadly refers to any task, function, procedure, or process performed, directly or indirectly, within a generative artificial intelligence model scoring environment 200 to generate a recommendation regarding the issue identified when analyzing the generative artificial intelligence model. In certain embodiments, within the scan results, a recommendation is made to the user regarding how to best fix the model based off the discoveries and vulnerabilities confirmed within the system. In certain embodiments, the recommendation operation guides the user in the process of allocating resource (e.g., time, money, people) into fixing root cause

As used herein, a summary operation broadly refers to any task, function, procedure, or process performed, directly or indirectly, within a generative artificial intelligence model scoring environment 200 to generate a summary regarding the analysis of the generative artificial intelligence model. In certain embodiments, a scan result summary is automatically generated by the system upon completion of the analysis of the generative artificial intelligence model. In certain embodiments, the summary outlines what happened within the scan, what worked, what failed, a note regarding the findings, or a combination thereof. In certain embodiments, the summary is a precursor to the recommendation.

As used herein, a benchmarking operation broadly refers to any task, function, procedure, or process performed, directly or indirectly, within a generative artificial intelligence model scoring environment 200 to generate a benchmark regarding the analysis of the generative artificial intelligence model. As used herein, an indexing operation broadly refers to any task, function, procedure, or process performed, directly or indirectly, within a generative artificial intelligence model scoring environment 200 to generate an index regarding the generative artificial intelligence model. In certain embodiments, by executing model scans the generative artificial intelligence model analytics system generates benchmarks and indexes about various aspects of the models. In certain embodiments, the model scanner automatically benchmarks the entire set of scanned models, enabling authorized user visibility of the run time characteristics of the models. In certain embodiments, the characteristics can include vulnerabilities and operational concerns such as time taken regarding the generative artificial intelligence model. In certain embodiments, benchmarking uses a model score to provide a relative comparison of different models, including third party models. In certain embodiments, by indexing the model, groups using similarly orientated models may be identified to enable benchmarking statistics to be better understood.

Modifications, additions, or omissions may be made to the environment 200 without departing from the scope of the present disclosure. For example, in some embodiments, the environment 200 may include any number of other components that may not be explicitly illustrated or described.

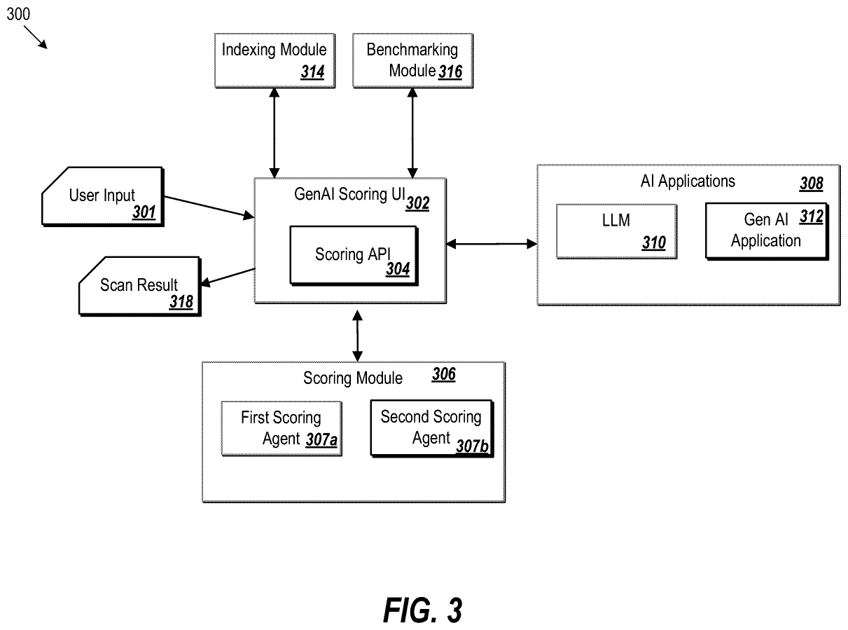

FIG. 3 shows a block diagram of an artificial intelligence (AI) model analytics system 300, in accordance with one or more embodiments of the present disclosure. In some embodiments, the system 300 may be configured to analyze AI applications and/or models. For example, in some embodiments, the system 300 may analyze one or more AI applications 308 based on the contents generated by the AI applications 308. In some embodiments, the AI applications 308 may include any types of suitable AI applications such as an LLM 310 and a Gen AI application 312.

In some embodiments, the system 300 may include a generative artificial intelligence (Gen AI) scoring user interface (UI) 302 (“scoring UI 302”), a scoring module 304, an indexing module 314, and/or a benchmarking module 316.

In some embodiments, the scoring UI 302 may correspond to the user interface module 122 of FIG. 1. In some embodiments, the scoring AI 302 may be configured to obtain user input 301 from a user. In some embodiments, the user input 301 may include a command causing the scoring UI 302 to perform one or more operations. For example, the user input 301 may cause the scoring UI 302 to register a scoring agent, register an AI application, and/or to run scoring of the AI application. For example, the user input 301 may register an AI application to be tested to the AI applications 308. In some embodiments, the AI applications may include different types of AI models such as a generative AI model and LLM. In some embodiments, registering process (e.g., registering of the scoring agent and/or the AI application) may include providing frameworks of the scoring agent and/or the AI application to the system 300 such that the scoring API 304 may integrate the scoring agent and/or the AI application to the system 300 and/or the scoring UI 302.

In some embodiments, the scoring UI 302 may include a scoring API 304. In these and other embodiments, the scoring UI 302 may be configured to facilitate the analysis and/or testing of AI models. For example, in some embodiments, the scoring UI 302 may communicate with the scoring module 306, the indexing module 314, and/or the benchmarking module 316 via the scoring API 304. For example, the scoring UI 302 may transmit and/or receive data using the scoring API 304.

In some embodiments, the scoring UI 302 may provide, via the scoring API 304, targets to be tested to the AI applications 308. For example, the targets may include an input, such as a query, a question, and/or a command, to cause the AI applications 308 to generate an output. For example, the LLM 310 may be a customer service chatbot for an entity. The target may include a query for the entity, and the output may include an answer to the query.

In some embodiments, the scoring module 306 may include one or more agents configured to evaluate and score AI-generated contents. For example, the scoring module 306 may include a first scoring agent 307a and a second scoring agent 307b (collectively referred to as “scoring agents 307”). While two scoring agents 307 are illustrated, the scoring module 306 may include any suitable number of scoring agents. For example, the scoring module 306 may include more or less scoring agents.

In some embodiments, the scoring agents 307 may be configured to generate scores the AI applications 308. For example, each of the scoring agents 307 may each generate corresponding scores. For example, the first scoring agent 307a may generate a first score, and the second scoring agent 307b may generate a second score. In some embodiments, each of the scoring agents 307 may generate the scores based on different parameters. For example, the first scoring agent 307a and the second scoring agent 307b may respectively generate the first score and the second score based on different scoring parameters. In some embodiments, the parameters may include predefined criteria such as safety and alignment of the AI applications.

In some embodiments, the scoring agents 307 may be defined such that that the scoring agents 307 conform to framework of the system 300. For example, the codes, format of the scoring agents 307, types of inputs and outputs may be structured to conform to requirements of the system 300 and/or the scoring module 306. In some embodiments, the scoring agents 307 may be machine learning (ML) models. Additionally or alternatively, the scoring agents 307 may be rules based systems and/or a combination of an ML model and a rules-based system.

In some embodiments, the scoring agents 307 may include internal agents provided by the system 300. For example, the first scoring agent 307a may be an internal agent provided by the system 300. In these and other embodiments, the first scoring agent 307a may include algorithms and/or systems configured to evaluate and score the AI-generated contents. In some embodiments, the internal agents (e.g., the first scoring agent 307a) may help improve quality, reliability, and/or strategic alignments of AI outputs. For example, the internal agents may scan the AI-generated contents based on standard metrics to generate the scores. For example, in some embodiments, the metrics may include bias, toxicity, faithfulness, among others.

In some embodiments, the scoring agents 307 may be an external agent provided by external systems, services, and/or users. For example, the second scoring agent 307b may be provided by the external systems, services, and/or users. For example, the user input 301 may include the second scoring agent 307b. In some embodiments, the scoring API 304 may cause the scoring agent 307b to be registered in the scoring module 306. In some embodiments, the external agents (e.g., the second scoring agent 307b) may allow the system 300 to evaluate AI-generated contents based on independent and/or custom standards. In some embodiments, the external agents may provide an additional layer of validation to help improve unbiased assessment of AI outputs.

In some embodiments, the indexing agent 314 may be configured to aggregate the scores generated by the scoring agents 307. For example, the indexing agent 314 may aggregate the first score and the second score. In some embodiments, the indexing agent 314 may aggregate the scores in any suitable manner. For example, in instances in which the scores are represented numerically, the scores may be aggregated as total score, average score, among others.

In some embodiments, the benchmarking agent 316 may be configured to enable comparison of the scores. For example, the benchmarking agent 316 may compare the first score and the second score. In some embodiments, the comparison may provide further insights into the scores. For example, the comparison of the scores may provide insights on strong and/or weak functions of the AI applications 308. For example, the first score may represent bias of the AI applications 308, and the second score may represent instances and/or presence of hallucinations in the AI applications 308. In instance where the first score is high and the second score is low, the comparison of the first score and the second score may reflect that the AI applications 308 are efficient with respect to bias (e.g., shows lower bias) while there is room for improvement with respect to hallucinations.

In some embodiments, the benchmarking agent 316 may compare the scores generated using the scoring agents 307 to evaluations done using external services and/or third parties. For example, the system 300 may communicate, via the benchmarking agent 316, with a third-party system configured to evaluate the AI applications based on similar metrics as the scoring agents 307. The benchmarking agent 316 may compare the scores of the scoring agents 307 to the scores and/or evaluations of the external services such that integrity of the scoring agents 307 may be further confirmed and/or verified.

In some embodiments, the scoring AI 302 may generate a scan result 318. The scan result may represent performance of the AI applications 308 based on the scores generated by the scoring agents 307. Additionally or alternatively, the scan result 318 may include aggregated score generated by the indexing module 314 and/or the comparison of the scores generated by the benchmarking module 316.

Modifications, additions, or omissions may be made to the AI model analytics system 300 without departing from the scope of the present disclosure. For example, in some embodiments, the AI model analytics system 300 may include any number of other components that may not be explicitly illustrated or described.

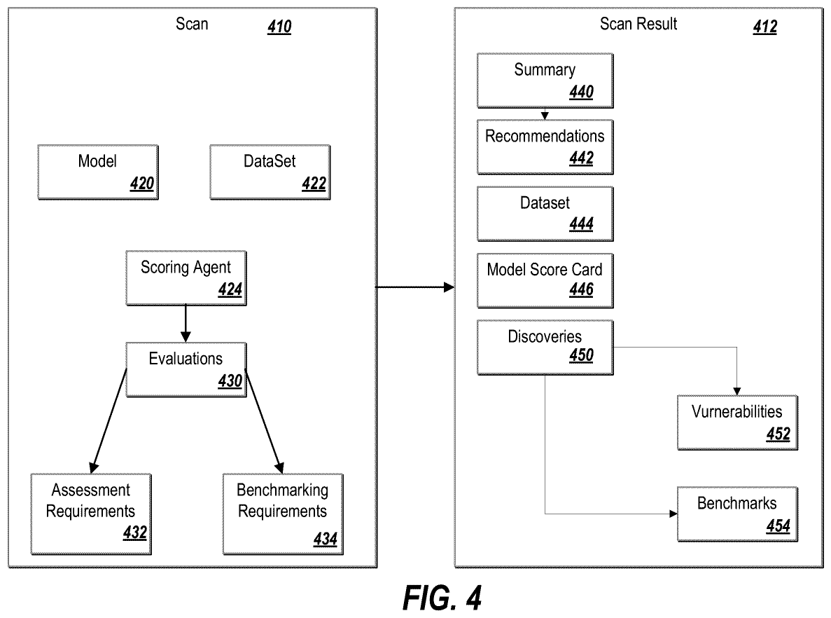

FIG. 4 shows a functional block diagram of the operation a generative artificial intelligence model analytics system. More specifically, in certain embodiments, a generative artificial intelligence model analytics operation includes a scan portion 410 and a scan result portion 412.

When performing the scan portion 410, the generative artificial intelligence model analytics system receives a model to be analyzed 420, a data set associated with the model 422, or a combination thereof. A scoring agent 424 is then applied to the model to be analyzed 420 and the data set 422. In certain embodiments, the scoring agent makes use of assessment and benchmarking evaluation specifications. In certain embodiments, the scoring agent 424 generates one or more evaluations 430 regarding the model 420, the data set 422, or a combination thereof. In certain embodiments, the evaluation 430 may include assessment requirements 432, benchmarking requirements 434, or a combination thereof.

When performing the scan result portion 412, the generative artificial intelligence model analytics system generates a summary 440 regarding the scan, recommendations 442 regarding the scan, or a combination thereof. In certain embodiments, the generative artificial intelligence model analytics system provides information regarding the data set 444, model score card information 446, or a combination thereof. In certain embodiments, the generative artificial intelligence analytics system generates one or more discoveries 450 regarding the model being analyzed. In certain embodiments, when performing the scan result portion 410, the generative artificial intelligence model analytics system provides information regarding vulnerabilities 452 associated with a discovery, benchmarks 454 associated with the discoveries, or a combination thereof.

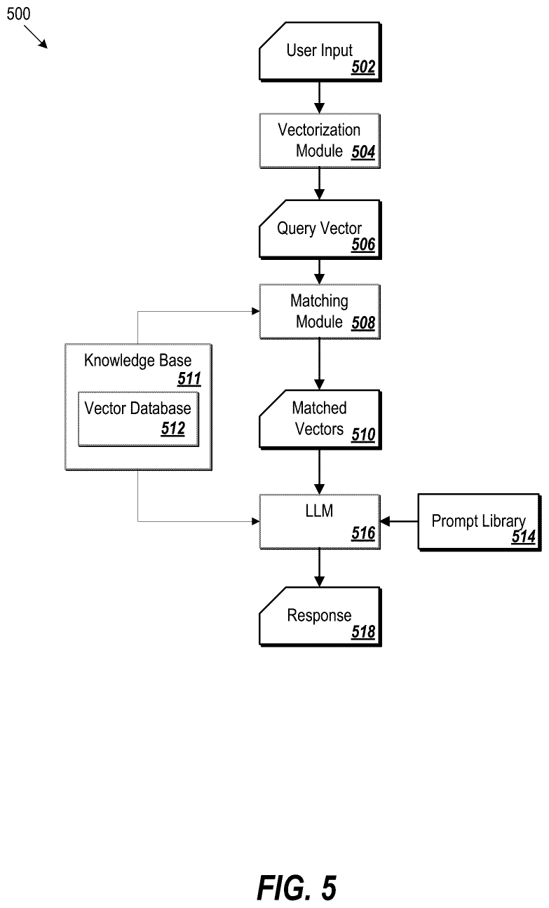

FIG. 5 is a flow diagram for a process 500 of generating a response using an AI model, in accordance with one or more embodiments of the present disclosure. One or more operations of the process 500 may be performed by any suitable system, apparatus, or device such as, for example, the information handling system 100 of FIG. 1 and/or the analytics system 300 of FIG. 3.

In some embodiments, a user input 502 may be obtained at a vectorization module 504. In some embodiments, the vectorization module 504 may be configured to transform the user input 502 into a vector format. For example, the vectorization module 504 may generate a query vector 506 representing the user input 502. In some embodiments, the vectorization module 504 may use any suitable vectorization techniques.

In some embodiments, a matching module 508 may obtain the query vector 506. In some embodiments, the matching module 508 may be configured to run query of the query vector 506 with respect to a vector database 512. For example, in some embodiments, a knowledge base 511 may include the vector database 512. In some embodiments, the knowledge base 511 may be a centralized repository of information that AI systems may use to enhance their understanding and performance. The knowledge base 511 may include structured and/or unstructured data, documentation, and other relevant resources. In some embodiments, the knowledge base 511 may include information from regulatory bodies across different fields such as AI, healthcare, Financial services, among others. In some embodiments, the vector database 512 may be a type of database configured to store, manage, and retrieve high-dimensional vectors, which may be numerical representations of data. The vectors may represent complex data such as text, images, and audio in a way that machines can understand and process. The matching module 508 may use identify vectors from the vector database 512 that may be related and/or relevant to the query vector 506. For example, the matching module 508 may identify matching vectors 510.

In some embodiments, an LLM 516 may be configured to generate a response 518 corresponding to the user input 502 based on the vector database 512, matched vectors 510, and prompt library 514. For example, data corresponding to the matched vectors 510 may be obtained from the vector database 512 to generate the response 518 using the LLM 516. In some embodiments, the response 518 may include citations (e.g., sources that were relevant to the response 518) and/or confidence scores (e.g., representing how confident the LLM 516 is of the response 518). In some embodiments, the prompt library 514 may include a curated collection of prompts used to guide AI models in generating specific outputs. These prompts may be designed to elicit desired responses from AI systems, improving their performance and consistency. These prompts may be vetted by Subject Matter Experts and help benchmark any new versions of the AI system. In these and other embodiments, the LLM 516 may be guided using one or more prompts from the prompt library 514 in generating the response 518.

Modifications, additions, or omissions may be made to the AI model analytics process 500 without departing from the scope of the present disclosure. For example, in some embodiments, the AI model analytics process 500 may include any number of other components that may not be explicitly illustrated or described

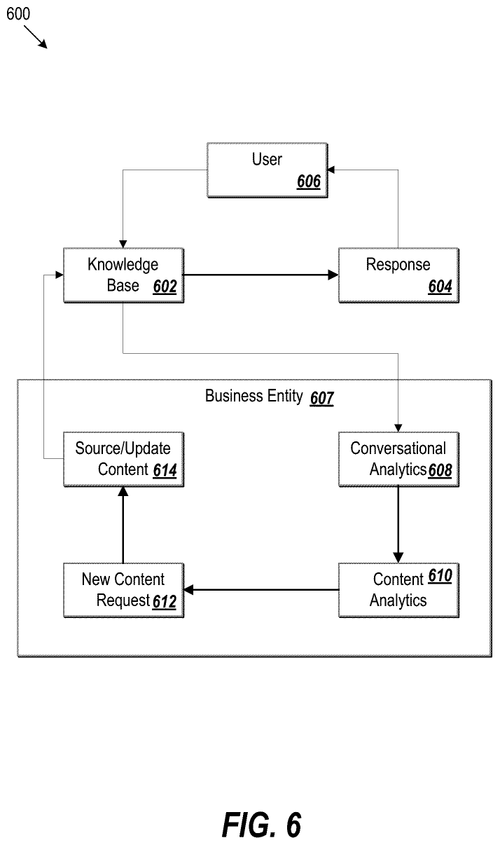

FIG. 6 illustrates a flow diagram for a system 600 configured for system of record, in accordance with one or more embodiments of the present disclosure. In some embodiments, the system 600 may include a knowledge base 602. In some embodiments, the knowledge base 602 may correspond to the knowledge base 511 of FIG. 5. In some embodiments, the system 600 may be configured to continuously update contents and/or data stored in the knowledge base 602.

In some embodiments, the knowledge base 602 may include vector database (e.g., the vector database 512 of FIG. 5). Additionally or alternatively, the knowledge base 602 may include regulations and policies repository. In some embodiments, data stored in the knowledge base 602 may be used to generate a response 604 in response to a query from a user 606. For example, in response to the query from the user 606, the data stored in the knowledge base 602 may be used with an AI model (e.g., an LLM) to generate and provide the response 604 to the user 606. In some embodiments, the user 606 may provide feedback with respect to the response 604. For example, the user 606 may provide whether the response 604 is valid.

In some embodiments, the response 604 may include additional information regarding the response 604 such as information about the AI model used to generate the response 604. For example, in some embodiments, the response 604 may include scores associated with the AI model. For example, in some embodiments, the scores may be generated for the AI model using a Gen AI model analytics system such as the generative artificial intelligence model analytics system 300 of FIG. 3. For instance, the Gen AI analytics system may generate scores for the AI model used to generate the response 604.

In some embodiments, the system 600 may keep a system of record for the queries, responses, AI models used, scores for the AI models, and any other suitable system-generated logs and signals that may be helpful in auditing and reporting process of the AI models. In some embodiments, the system of record may be kept in different types of databases or database systems configured to store data models. For example, the system may include a NoSQL (Not Only Structured Query Data) configured to store the system of record.

In some embodiments, the data stored in the knowledge base 602 may be updated, revised, and/or modified. For example, the user 606 may provide new information to the knowledge base 602. In some embodiments, the query from the user 606 and the corresponding 604 may also be used to update the data in the knowledge base.

In some embodiments, the knowledge base 602 may be updated with respect to a particular entity such as a business entity 607. For example, the knowledge base 602 may be configured to include data associated with the business entity 607, such that the AI models may generate appropriate responses in response to queries associated with the business entity 607. In some embodiments, the knowledge base 602 may be updated with respect to the business entity 607 based on one or more analytic operations.

For example, the system 600 may include conversational analytics module 608 configured to capture, analyze, and interpret data from human conversations (e.g., conversation and/or interaction between a human operator and the AI applications), whether through voice, text, or other interactive mediums. Conversational analytics module 608 may focus on understanding patterns, sentiments, intents, and outcomes from the conversations. For example, a customer support center may capture analytics to evaluate the performance of its chatbots and human agents. By analyzing conversation logs, the company can identify common customer issues, measure customer satisfaction, and improve service quality. Such information may be provided to the knowledge base 602 to be stored.

Additionally or alternatively, the system 600 may include content analytics module 610 configured analyze regulatory and policy content to extract meaningful insights. This can include any rules and regulations included in the document. The content analytics module 610 may help understand the evolving regulatory landscape and keep the content updated and fresh. For example, an AI or healthcare or financial regulation that was published in the last few years and has published revisions on a quarterly cadence may be updated in the knowledge base 602.

In some embodiments, in response to identifying new data or content using the conversational analytics module 608 and/or the content analytics module 610, a new content request 612 may be generated. In these and other embodiments, the new content (e.g., the regulatory and policy content) may be obtained. In these and other embodiments, updated content 614 may be made to the knowledge base 602.

Modification, additions, or omissions may be made to the system 600 without departing from the scope of the present disclosure. For example, in some embodiments, the system 600 may include any number of other components that may not be explicitly illustrated or

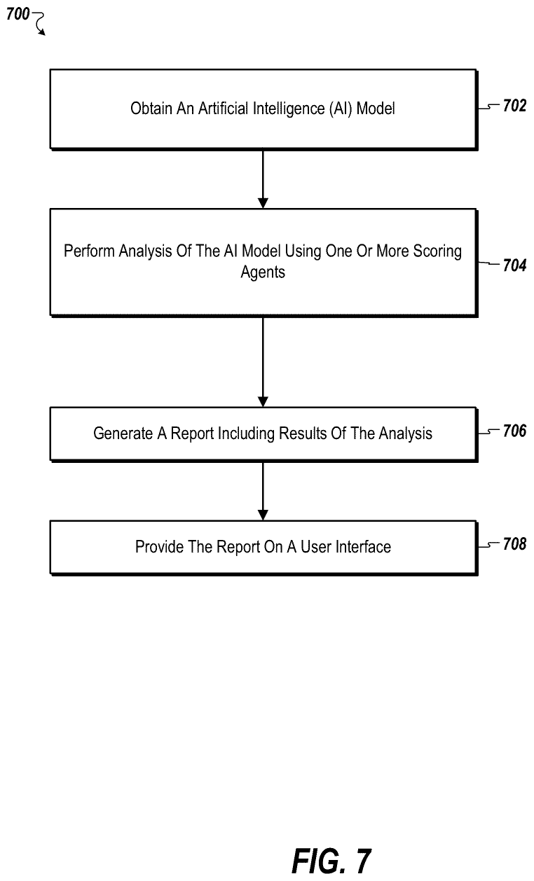

FIG. 7 is a flow chart of an example method 700 of performing analysis of an AI model, arranged in accordance with at least one embodiment of the present disclosure. One or more operations of the method 700 may be implemented by any suitable systems such as the analytics system 300 of FIG. 3 and/or the system 600 of FIG. 6. Although illustrated as discrete steps, various steps of the method 700 may be divided into additional steps, combined into fewer steps, or eliminated, depending on the desired implementation. Additionally, the order of performance of the different steps may vary depending on the desired implementation.

In some embodiments, the method 700 may include a block 702. At block 702, an artificial intelligence (AI) model may be obtained. In some embodiments, the AI model may be a generative AI model, such as an LLM. In some embodiments, the AI model may be obtained from a user. For example, the user may provide the AI model to be tested. In some embodiments, the AI model may be associated with a business entity. For example, the AI model may be configured to perform operations with respect to the business entity. For example, the AI model may be a chatbot performing customer support operations for the business entity.

At block 704, an analysis of the AI model may be performed using one or more scoring agents. In some embodiments, the scoring agents may be configured to score the AI model using scoring parameters. In some embodiments, the individual scoring agents of the one or more scoring agents may be configured to respectively generate individual scores of the AI model. In some embodiments, the individual scoring agents may have varying scoring parameters. In some embodiments, at least one scoring agent of the one or more scoring agents may be an internal agent, provided by the system. Additionally or alternatively, at least one scoring agent of the one or more scoring agents may be an external scoring agent provided by an external party, such as the user or the business entity. In some embodiments, the scoring agents may correspond to the scoring agents 307 of FIG. 3.

At block 706, a report including results of the analysis may be generated. In some embodiments, the results of the analysis may include one or more of: the individual scores generated using the one or more scoring agents; aggregated scores generated by aggregating the individual scores; or comparison of the individual scores.

At block 708, the report may be provided on a user interface. In some embodiments, the user interface may be provided on a user device (e.g., the user device 204 of FIG. 2). In some embodiments, the report may be customized based on a user using the user interface and/or requesting the report. For example, the report may be tailed to the specific needs and responsibilities of different roles within an organization or a business entity. Such process may help provide different users with relevant information.

Modifications, additions, or omissions may be made to the method 700 without departing from the scope of the present disclosure. For example, one skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, in some embodiments, the method 700 may further include obtaining a query from a user; and generating a response to the query using the AI model and data stored in a knowledge base. In some embodiments, the knowledge based may correspond to the knowledge base 511 of FIG. 5 and/or the knowledge base 602 of FIG. 6.

In some embodiments, the method 700 may further include obtaining information updating the data stored in the knowledge base; making an update to the data stored in the knowledge base based on the information; and generating a record of the update. In some embodiments, the information may be obtained from analysis of conversational data. Additionally or alternatively, the information may be obtained from analysis of regulations and policies associated with an entity.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Additionally, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B” even if the term “and/or” is used elsewhere.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A method for performing a generative artificial intelligence model analytics operation, comprising:
obtaining an artificial intelligence (AI) model;
performing analysis of the AI model using one or more scoring agents;
generating a report including results of the analysis; and
providing the report on a user interface.

2. The method of claim 1, wherein the one or more scoring agents are configured to respectively generate individual scores for the AI model.

3. The method of claim 2, wherein the results of the analysis include one or more of:
the individual scores generated using the one or more scoring agents;
aggregated scores generated by aggregating the individual scores; or
comparison of the individual scores.

4. The method of claim 1, wherein the at least one scoring agent of the one or more scoring agents is an internal agent.

5. The method of claim 1, wherein the at least one scoring agent of the one or more scoring agents is an external agent.

6. The method of claim 1, wherein the AI model is a large language model.

7. The method of claim 1, further comprising:
obtaining a query from a user; and
generating a response to the query using the AI model and data stored in a knowledge base.

8. The method of claim 7, further comprising:
obtaining information updating the data stored in the knowledge base;
making an update to the data stored in the knowledge base based on the information; and
generating a record of the update.

9. The method of claim 8, wherein the record is stored in a NoSQL database.

10. The method of claim 8, wherein the information is obtained from analysis of conversational data.

11. The method of claim 8, wherein the information is obtained from analysis of regulations and policies associated with an entity.

12. The method of claim 1, wherein the report is customized based on a user using requesting the report.

13. One or more non-transitory computer-readable media storing instructions that, when executed by one or more processors, cause a system to perform operations, the operations comprising:
obtaining an artificial intelligence (AI) model;
performing analysis of the AI model using one or more scoring agents;
generating results of the analysis; and
providing the results of the analysis on a user interface.

14. The one or more non-transitory computer-readable media of claim 13, wherein the one or more scoring agents are configured to respectively generate individual scores for the AI model.

15. The one or more non-transitory computer-readable media of claim 14, wherein the results of the analysis include one or more of:
the individual scores generated using the one or more scoring agents;
aggregated scores generated by aggregating the individual scores; or
comparison of the individual scores.

16. The one or more non-transitory computer-readable media of claim 13, wherein the at least one scoring agent of the one or more scoring agents is an internal agent.

17. The one or more non-transitory computer-readable media of claim 13, wherein the at least one scoring agent of the one or more scoring agents is an external agent.

18. A system comprising:
a knowledge base storing data;
an AI model trained using the data stored in the knowledge base, the AI model further configured to generate a response in response to a query;
one or more analysis modules configured identify new data for the knowledge base, wherein the one or more analysis modules are further configured to update the knowledge base with the new data; and
a record keeping module configured to record changes made to the knowledge base and the response generated using the AI model.

19. The system of claim 18, wherein the one or more analysis modules include one or more of a conversational analytics module or a content analytics module.

20. The system of claim 18, wherein the knowledge base includes one or more of a vector database or a regulation and policies repository.
